(19) United States
(12) Patent Application Publication
(10) Pub. No.: US 2011/0292982 A1
(43) Pub. Date: Dec. 1, 2011

(54) Method of Using Average Phase Difference to Measure a Distance and Apparatus for the Same

(75) Inventors: Chun-Chin Chen, Taoyuan City (TW); Wei-Tun Peng, Hsinchu City (TW); Li-Rong Wang, Fengshan City (TW)

(73) Assignee: UNIBAND ELECTRONIC CORP., Hsinchu City (TW)

(21) Appl. No.: 12/986,438

(22) Filed: Jan. 7, 2011

(30) Foreign Application Priority Data
May 31, 2010 (TW) 099117504

(51) Int. Cl. H04B 17/00

(52) U.S. Cl. 375/224

(57) ABSTRACT

Apparatus for positioning and method for the same are disclosed. The apparatus comprises two transceivers and four time-to-digital converters. The time-to-digital converters compare the phase difference between two signals, one is the crystal oscillation and the other is the phase of the IF (intermediate frequency) signal extracted before ADC receiving by the transceiver. The method comprises the following steps: The first place transmits a first wireless signal by a first transceiver to the second place. The second place then responds a second wireless signal by a second transceiver to the first place. The first phase difference at the first place is then measured by the time-to-digital converter. The second phase difference at the second place is also measured. The distance between the first place and the second place is proportional to one half of the sum of first phase difference and the second phase difference.

### FIELD OF THE INVENTION

The present invention relates to a method of positioning and distance measurement by measuring the phase differences between a wireless signal received and a calibrated crystal oscillator frequency using a time-to-digital converter, particularly to, the averaging phase differences on several periods of the signals.

### BACKGROUND OF THE INVENTION

With the development of wireless communication, positioning technique can be widely applied on many fields and provide potential business market opportunities thus it is always a hot topic. For instance, in the global satellite position, back car radar, directional car search, people searching, or object searching are particularly useful for the team tours in mountain if the object tied with or team member to be searched bring a transceiver. One of positioning techniques may refer the RSSI (received signal strength indicator) to derive the distance of the object or people. The RSSI position technique involves using the RFID and antennas. To position an object in a positioning space, four antennas are demanded or in a 2D plane by three antennas. FIG. 1 depicts a planar position schematic diagram. Three antenna readers are assumed placed at position A, B, C and a target to be positioned is assumed at the point P. If the target has a transmitter to transmit a wireless signal then the antenna readers A, B, and C would receive the signal thereby the distances dₚ^{A}, dₚ^{B}, dₚ^{C} can be estimated according to the RSSI values detected. Accordingly, the coordinate of the P can be obtained by solving the coupling equations:

dₚ^{A}=\sqrt{(x_{A}−x_{P})²+(y_{A}−y_{P})²} (1)

dₚ^{B}=\sqrt{(x_{B}−x_{P})²+(y_{B}−y_{P})²} (2)

dₚ^{C}=\sqrt{(x_{C}−x_{P})²+(y_{c}−y_{P})²} (3)

However, the RSSI values are vulnerable and be affected by .environmental factors unless the RSSI values have be passed a long training time and/or correctness thereafter.

Another position method of the wireless signal positioning is by time arriving, which is found to be more precisely and less affected by environment than RSSI. Please refer to FIG. 2. A first signal is transmitted out by a first transceiver of user A at location A. After duration, t_{dur} the first signal arrive the location B. The second transceiver responds a second signal back at a post time t_{B} upon receiving the first signal. The second signal passes the same duration, t_{dur} to arrive location A. and received by the first transceiver. The time t_{A} represents the duration since the first signal is transmitted and the second signal is received by the same transceiver.

Hence, the distance d_{AB} between position A and position B can be expressed as:

$${d}_{AB} = \frac{{t}_{A} - {t}_{B}}{2} \times C$$

where C is the velocity of light.

In practice, both of the wireless signals are modulated signals transmitted according to a data packet protocol. That is the source information onto a baseband signal with a carrier frequency by the introduction of amplitude and/or phase perturbations. After the modulated signal received by the transceiver, the modulated signal are demodulated to the baseband signals. To position by using wireless signal technique, the crystal oscillation frequencies of the first transceiver and the second transceiver should be in consistence; otherwise, the arrival time would be incorrect.

To avoid the clock of an user A at location A is asynchronous with the clock of user B at location B, a preferred solution is that the user A transmits a third signal after a post time t_{C} again to the user B and then the user B at location B receives the third signal again after a post time t_{D}. Hence, the distance will be about:

$$\frac{{t}_{A} - {t}_{B} + {t}_{D} - {t}_{C}}{4}$$

The accuracy will be prompted if the signal transmitted and received twice and take an average thereof. Surely, many more transmitted and received repeatedly, more accuracy.

As aforementioned, an accuracy distance measurement may be further applied to position a target. It demands three transceivers transmitting signals to a transponder at location P so as to estimate the distances of dₚ^{A}, dₚ^{B}, dₚ^{C} and then using the coupling equations (1), (2), (3) so as to get the coordinate (x_{P}, y_{P}) of the location P.

In an embodiment, e.g. Nanotron, the data packet is transmitted by an ultra-wide band transceiver. The technique consumes a current about 150 mA and demands several milliseconds for each measurement.

The present invention provides a method of distance measurement by using a technique of the phase difference and apparatus for the same. It costs about dozens of nanosecond each time but can get an average phase difference of several periods over signals to improve the positing accuracy.

### SUMMARY OF THE INVENTION

The present invention provides a method of distance measurement by using a technique of the phase difference and apparatus for the same. It costs dozens of nanosecond each time but can get an average phase difference of several periods over signals to improve the positing accuracy.

The apparatus comprises two transceivers and four time-to-digital converters. The time-to-digital converters compare the phase difference between two signals, one is the crystal oscillation and the other is the phase of the IF (intermediate frequency) signal extracted before ADC receiving by the transceiver. The method comprises the following steps: The first place transmits a first wireless signal by a first transceiver to the second place. The second place then responds a second wireless signal by a second transceiver to the first place. The first phase difference at the first place is then measured by the time-to-digital converter. The second phase difference at the second place is also measured. The distance between the first place and the second place is proportional to one half of the sum of first phase difference and the second phase difference.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a planar positioning method using three RFIDs technique.

FIG. 2 shows a positioning method using time arrived in accordance with the prior art.

FIG. 3 shows function blocks of a narrow band width with QPSK modulated transceiver.

FIG. 4 shows a system of positioning technique by signal communication between two transceivers.

FIG. 5 shows a schematic timing diagram having four signals with different phases.

FIG. 6 shows a function block of a TDC in accordance with the present invention.

FIG. 7 shows a schematic diagram of using TDC to read the phase difference in accordance with the present invention.

FIG. 8 shows the average of phase differences of a data packet.

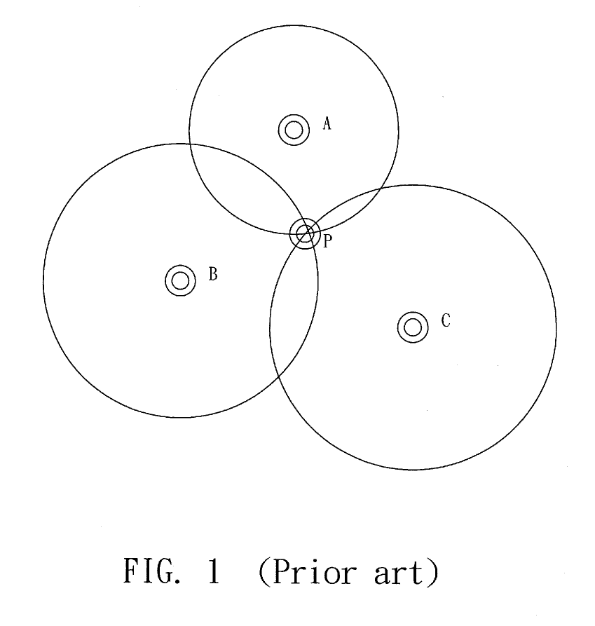

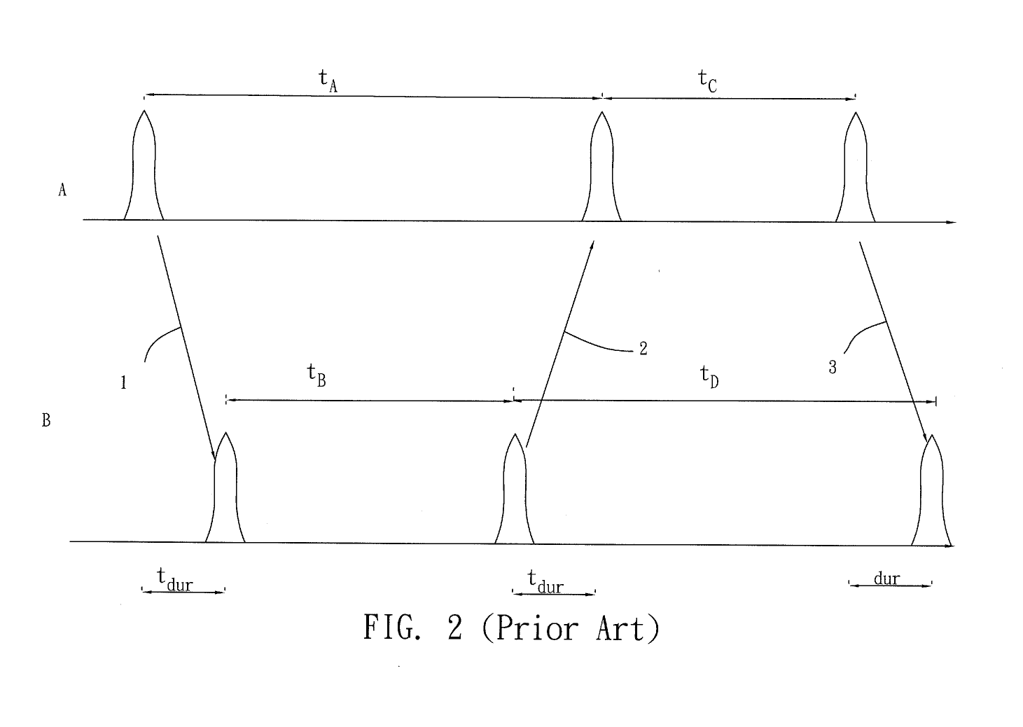

### DETAILED DESCRIPTION OF THE PREFERRED EMBODIMENT

As forgoing descriptions in the background of the invention, the time arriving technique demands signal being transmitted, received, response with another signal etc., repeatedly, to improve accuracy and further, the clock frequency at two locations should be consistence. Even the inconsistence just a little as 3 ns in a period of a signal, it may cause 1 meter positioning error.

The present invention provides a method of distance measurement between two locations by detecting a first average phase difference over several periods of the IF (intermediate frequency) signal with a crystal oscillator frequency at a location A and a second average phase difference for the same at location B. Surely, carrier signals for carrying the IF signals have to be calibrated so that the two frequencies at two locations are consistence. That is, the crystal oscillator frequencies of the two synthesizers should be the same.

However, about 1 to 20 ppm of frequency offset between two crystal oscillators are found generally. Hence, it needs to estimate the frequency offset and a further step to eliminate them. The frequency offset estimation between two crystal oscillators, please refer to the inventors' another patent with an application series number 98133853 in Taiwan by present inventors herein is incorporated by reference. As for the frequency offset cancellation technique please refer to the inventors' another patent with an application series number 099,117,505 in Taiwan. Herein, is incorporated by reference.

Therefore, the present invention will assume that the transceiver at location A has the same crystal oscillator frequency as that of the transceiver at location B. In addition, the transceiver according to the present invention is a narrow band transceiver to reduce the current consumption. The current consumption of the transceiver is of about 50 mA in accordance with the present invention. In addition, the baseband signal is a monotony pulse signal outputted from a digital processor, converted to an analog signal by DAC and then be filter to become a half-sine shaped IF signal . . . .

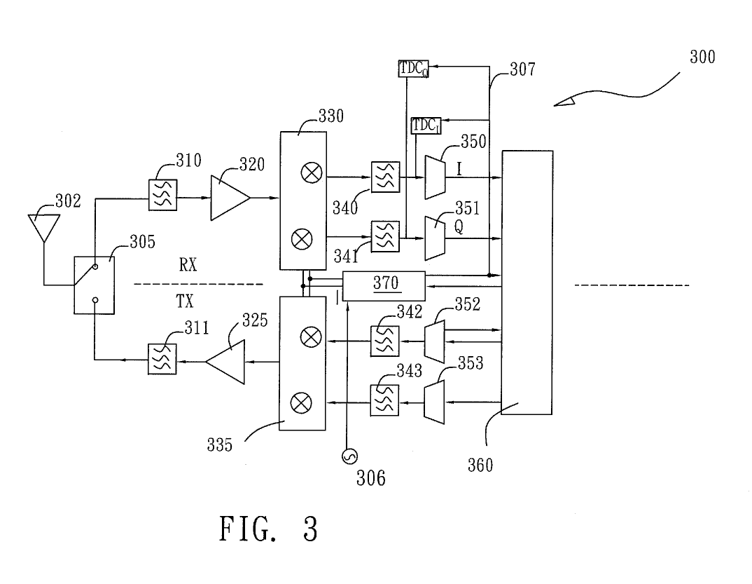

FIG. 3 shows a function block diagram of a narrow bandwidth transceiver 300 using OQPSK (offset quadrature phase shift keying) modulation technique. The transceiver 300 is coupled to a time-to-digital converter (TDC). In FIG. 3, the transceiver 300 has a crystal oscillator 306, an antenna 302, a switch 305, a digital processor 360, a frequency synthesizer 370, a receiver unit having a first filter 310, a low-noise amplifier 320, a mixer 330, two second filters 340, 341, two analog-to-digital converters (ADC) 350,351, and. a transmitter unit.

The crystal oscillator frequency 306 is processed by frequency synthesizer 370 and then generated a calibrated crystal oscillator frequency 307 and a calibrated carrier frequency. Calibration as described is on the basis of a wireless signal received by the transceiver 300. Thereafter, the carrier frequency and the crystal oscillator frequency are calibrated or adjusted accordingly so that two transceivers at two locations have consistent crystal oscillator frequencies, after back and fourth calibration for one or two times.

The transmitter unit includes a third filter 311, a power amplifier 325, a mixer 335, two fourth filters 342,343, digital-to-analog converters (DAC) 352,353, in series connected to the digital processor. The transmitter unit and receiver unit has a common frequency synthesizer 370 to generate predetermined frequencies, which include a calibrated crystal oscillator frequency 307, two calibrated first frequencies with phase 90 degree difference for the mixer 330 and two calibrated second frequencies with phase 90 degree difference for the mixer 335. Preferably, the wireless signal transmitted by the transceiver 300 is an OQPSK modulated signal. The calibrated second frequencies are higher than calibrated first frequencies by 2 MHz

The TDC is to get a plurality phase differences between the calibrated crystal oscillator frequency 307 and the IF frequency prior to enter ADC 350, 351 to avoid quantization error. As is shown in FIG. 3, the TDC includes TDC_{I} and TDC_{Q}. An average value of phase difference of phase differences is further taken. The IF frequency is the wireless signal received by the transceiver and then demodulated. Worthwhile, the calibrated crystal oscillator frequency is an integer multiple of the IF frequency.

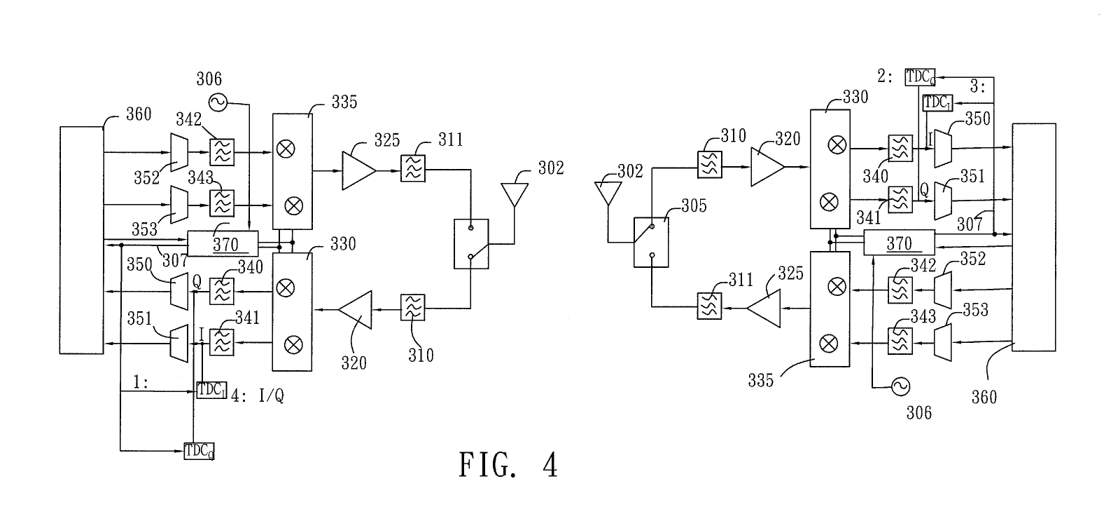

FIG. 4 shows a phase difference comparison system having two transceivers at location A and location B, respectively and four TDC. The transceiver 300 coupled with TDC_{I} and TDC_{Q} at location A is provided to compare the calibrated crystal oscillator frequency 307, which is a frequency of the crystal oscillator 306 proceeded an calibration process by the frequency synthesizer 370, with the IF frequency, which is extracted from the demodulated signals after two second filters 340, 341 but prior to enter ADC 350, 351. The demodulated signals are a wireless signal received by the transceiver and demodulated by the mixer 330. The demodulated signal includes an in phase part (real part) I_DATA and a quadrature part (image part) Q-Data. The average phase difference detection is performed by comparing frequency of I_DATA with the frequency 307 by TDC_{I} and by comparing the frequency of Q_DATA with the frequency 307 by TDC_{Q}.

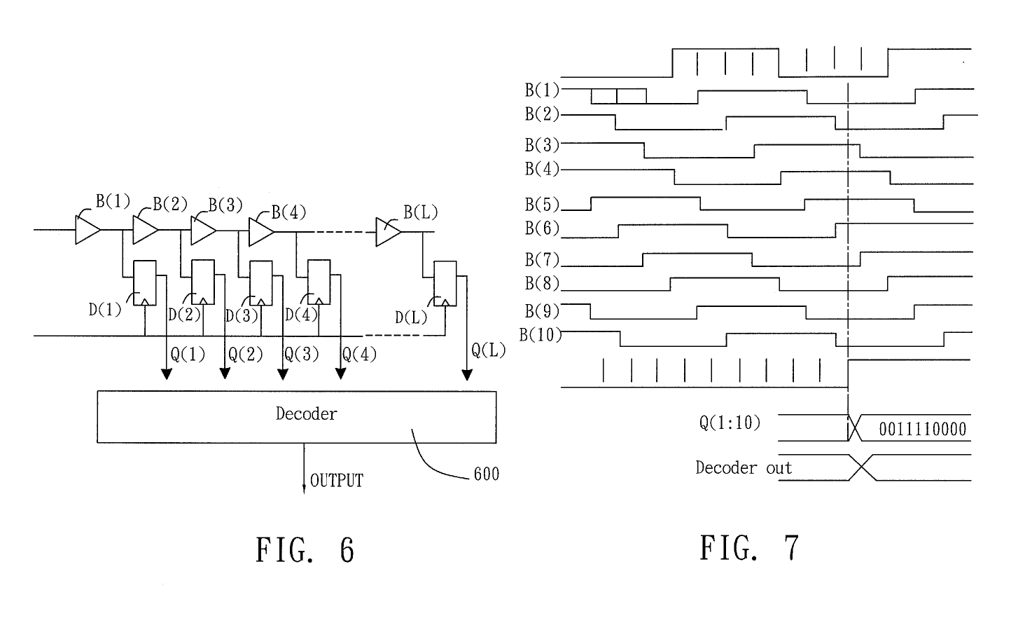

According to a preferred embodiment of the present invention, the baseband signal is a sine wave of 500 kHz, and the ultra-high frequency (UHF) carrier frequency is of 2 MHz after modulation. The sum of them is thus 2.5 MHz. On the other hand, the crystal frequency is of 20 MHz. Although two frequencies are not equal, but 20 MHz is an integer multiple of 2.5 MHz. Therefore, to carry out the phase difference detection by TDC, in one embodiment, the calibrated crystal oscillation frequency 307 may be down to 2.5 MHz by a frequency divider. In another embodiment, the IF signal frequency 2.5 MHz may be up to 20 MHz by a frequency multiplier, or a further preferred embodiment, neither up or down any but is performed by TDC directly, as shown in FIG. 6. The flip-flops use the calibrated crystal oscillation frequency 307 of 20 MHz as an edge trigger clock signal and the IF signal 2.5 MHz as an input signal. Please refer to FIG. 6. This does not affect the interpretation of the results. For example, the delay time of a buffer is 200 ps, it provides 6 cm precision. For a frequency of 2.5 MHz, the period will be 4×10⁻⁷ seconds and the light propagation distance by this period will be 120 m. For a 20 MHz crystal oscillator frequency, the light propagation distance by one period will be 15 m. Therefore, the distance read by the TDC may be “S+15 m×N” where N=0, 1, 2, 3, 4, 5, 6, or 7 and N is determined by the size of positing space.

Similarly, the transceiver 300 coupled with TDC_{I} and TDC_{Q} at location B is provided to compare the calibrated crystal oscillator frequency 307, which is designated as “3:” and is a frequency of the crystal oscillator 306 proceeded an calibration process by the frequency synthesizer 370, with the IF frequency, which is denoted as “2” and is extracted from the demodulated signals after two second filters 340, 341 but prior to enter ADC 350, 351. The demodulated signals are a wireless signal received by the transceiver and demodulated by the mixer 330. The demodulated signal includes an in phase part (real part) I_DATA and a quadrature part (image part) Q-Data. The average phase difference detection is performed by comparing frequency of I_DATA with the frequency 307 by TDC_{I}, and by comparing the frequency of Q_DATA with the frequency 307 by TDC_{Q}.

The processes of transmitting and receiving are depicted respectively, as follows:

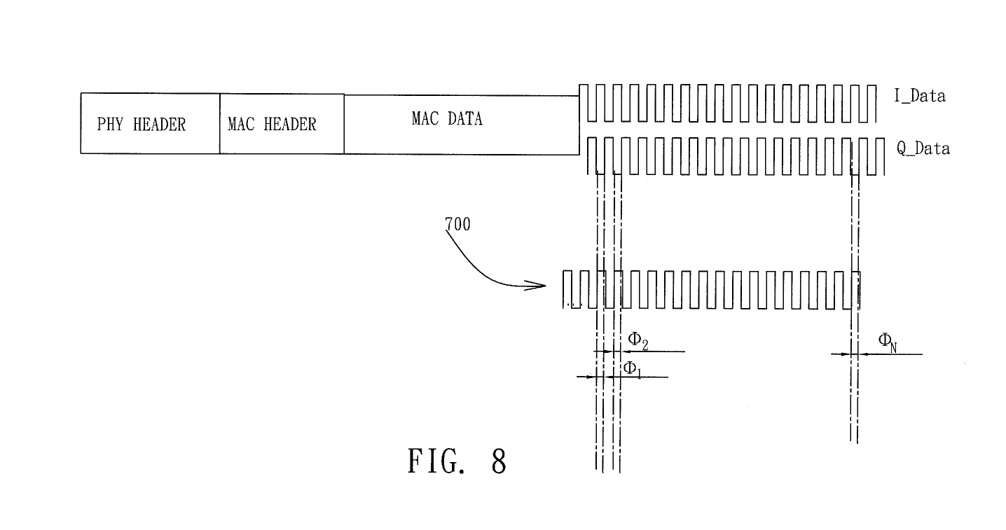

Transmitting: While the transceiver 300 is switched to the transmitting unit, the digital processor 360 provides packet headers include: a physical layer header, a MAC header and MAC information, which provide address to tell where to send, and a checksum for check the completeness of the packets, please also refer to FIG. 8. The digital processor (microprocessor) 360 provides a signal source with a frequency of 0.5 MHz. The signal source is provided by the crystal oscillator frequency proceeded with a calibration process by the synthesizer 370. The signal is then converted to an analog by the digital-to-analog converter DAC 352,353, then shaped by the fourth filters which are also half sine wave filters (half-sine filter) 342, 343. The half sine shaped wave is fed to the mixer 335. The synthesizer 370 also provides two calibrated carrier signals with phase difference 90-degree thereof to the mixer 335. The two carrier signals and the half Sine waves are modulated by the mixer 335 to form wireless data packets with a frequency of 2450 MHz. The wireless data packets are then amplified by the power amplifier 325 and then through the first filter 311 band pass filter, antenna 302 emits out.

Receiving: While the transceiver 300 is switched to a receiving mode, the antenna 302 receives the wireless signal with data packet. The wireless signal is filtered by the first filter 310, which is a band pass filter with a frequency band of about 2450.5 MHz. The band passed signal is then amplified by the low-noise amplifier 320 and then inputting to the mixer 330 to reduce the frequency. The mixer 330 provides two frequencies of about 2448 MHz and with a phase difference 90-degree in between to demodulate the band passed signal. The mixer 370 provides cosine waves which include a frequency sum term and a frequency deduction term in a real part, and sine waves which include also a frequency sum term and a frequency deduction term in an image part. The second filters 340, 341 are provided to filter out the frequency sum terms. The frequency deduction terms pass the second filters 340, 341, which are the IF signal with frequencies of about 2.5 MHz. The IF signals include a half sine baseband frequency of about 0.5 MHz. The IF signals are then converted by ADC 350, 351 to become digital data packets: I_DATA and Q_DATA. The microprocessor 360 is provided to take the forgoing packet heads. Worth to note, the frequency synthesizer 370 provides 2450 MHZ for the transmitter mode and 2448 MHZ for the receiver mode.

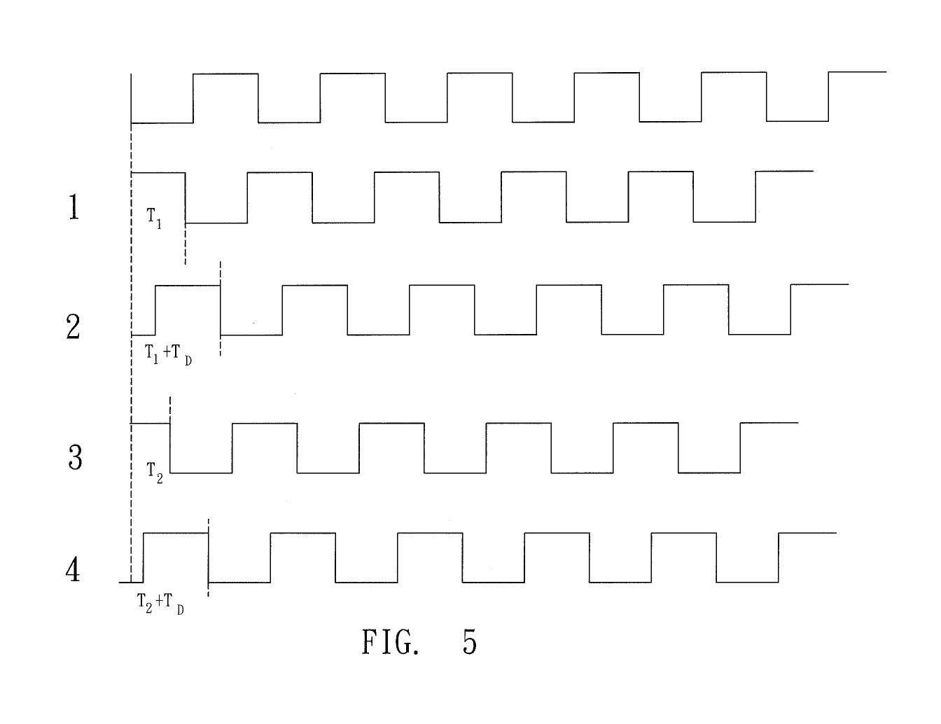

FIG. 5 depicts a timing diagram showing phases of four IF signals at four time points 1, 2, 3, 4, and the signals are fetched at four sites 1:, 2:, 3:, 4:, respectively, as shown in FIG. 4. The number sequence represents event occurrence sequence also. At the time points 2 and 4, the signals are received and processed through the second filters 340, 341 but before entering the ADC 350, 351 at location B and at location A, respectively. At the time point 1, 3, the signals are calibrated to oscillator frequencies.

Referring still to FIG. 5, the diagram illustrates the concepts of distance measurement by the phase difference, wherein the duration T_{D} is the arriving time and to be determined while a signal is transmitted by the first transmitter and received by the second receiver.

Since the phase difference of the two signals (time point 4 and time point 1) at the location A is:
T₂+T_{D}−T₁ and the phase difference of the two signals (time point 3 and time point 2) at the location A is: T₁+T_{D}−T₂. Thus,

(T₂+T_{D}−T₁)+(T₁+T_{D}−T₂)=2T_{D} (4)

i.e. if we sum the phase difference at location A with that of location B we can obtain a double of the arriving time.

Referring to FIG. 6, it shows a structure of time-to-digital converter (TDC).

In FIG. 6, there are L in number of buffers: B (1), B (2) . . . B (L) in series connected and a corresponded number of D-type flip-flop D (1), D (2) . . . D (L), and a decoder 600. An input terminal IN1 of the first buffer B (1) connected to a signal, according to an embodiment of the present invention is to receive a signal at 4: The IF signal or 2: the IF signal, they will be buffer B (1), B (2) . . . B (L) by the delay. The D-type flip-flop D (i) is a positive edge-triggered clock reference frequency signal by a control input from the input terminal IN2. In accordance with this embodiment of the invention is the time 1: 307 or the signal or time 3: the signal 307 of the signal. Of comparing time 1 and time point of 4 Comparison of the signal phase and time point 2 and time 3, the phase difference signal. The D-type flip-flop D (i) the input is taken from the buffer B (i) output. D-type flip-flop D (i) of the output Q (i) is connected to the decoder 600 to read out such as the decimal or hexadecimal values to facilitate reading the 0, 1 binary code.

The sum of time delay of total buffers T_{TOT} equal to one clock period i.e., is of 1/f. Take the frequency 2.5 MHz as an example, the period is of 400 ns and thus T_{TOT}=400 ns. Each buffer B (i) contains an even number of inverters. For two inverters to constitute a minimum buffer D (i) is concerned, it costs of about 20 ps (10-12 second) delay. The distance resolution will be up to 20 ps×3×108 m/s=6×10−3 m. Such resolution would demand very large number of buffers and latches. Practically, the resolution is lower than to reduce their numbers.

FIG. 7 shows a timing diagram, which the TDC is used to measure the phase differences at the two time points of 1, 4, shown in the FIG. 4. In FIG. 7, only 10 buffers and only one sampling time are shown. In fact, their number will be a hundred times this value and several sampling time simultaneously. In practice, due to the two time points 1, 4 are of the same frequency, so the decoder can simultaneously detect multiple cycle phase differences as shown in FIG. 8. In accordance the present invention, several phase differences under cycles, and then take their average. Therefore, the imprecision of reading phase difference caused by signal distortion during modulation or demodulation would be decreased to minimum.

The benefits of the present invention are:

(1). The distance measurement or positing a target is conducted by measuring the phase differences, particularly, to use an average phase difference on several cycles to improve accuracy. Consequently, any imprecision caused by the distortion of wave shape of the signal during propagation can be alleviated.

(2). The IF signals with sine shaping so that the signal distortion of narrow bandwidth.

(3). The phase measurement is performed before the signal entering the ADC. Thus the quantization error can be avoided.

(4). The present invention provides an easy implement method using low-IF receiver for positioning.

What is claimed is:

1. A method of using average phase difference to measure a distance between two locations, comprising the steps of:
transmitting a first wireless signal to a second location by a first low intermediate frequency transceiver (LIFTRX) at a first location;
receiving said first wireless signal at said second location and thereafter responding a second wireless signal to said first location by a second LIFTRX;
demodulating said second wireless signal to obtain a second intermediate frequency (IF) signal with two parts having 90° phase difference in between, and comparing said two parts of said second IF signal prior to enter two analog-to-digital converters (ADCs), respectively, with a first oscillator frequency by two first time-to-digital converters (TDCs) to get a plurality of phase differences and accordingly get two second average phase differences, wherein said first oscillator frequency is generated by a frequency synthesizer of said first LIFTRX and have been done a process of frequency offset cancellation;
demodulating said first wireless signal to obtain a first IF signal with two parts having 90° phase difference in between, and comparing said two parts of said first IF signal prior to enter said ADCs, respectively, with a second oscillator frequency by two second TDCs to get a plurality of phase differences and accordingly get two first average phase differences, wherein said second oscillator frequency is generated by a frequency synthesizer of said second LIFTRX and have been done a frequency offset cancellation; and
calculating said distance which is a half of sum of said first average phase differences and said second average phase differences times light velocity.

2. The method of claim 1 wherein said first LIFTRX has a first frequency synthesizer to generate a first carrier signal and a first crystal oscillator frequency and further said second LIMFTRX has a second frequency synthesizer to generate a second carrier signal and said second crystal oscillator frequency.

3. The method of claim 1 wherein said process of frequency offset cancellation is done in accordance with said wireless signal transmitted by each other transceiver.

4. The method of claim 1 wherein said two TDCs include one for an in phase part of said IF signals and the other for a quadrature part of said IF signals, and each has a first input terminal connected to said frequency synthesizer and a second input terminal connected to an input terminal of said ADC.

5. The method of claim 1 wherein said IF signal includes a half-sine wave shaped pulse signal.

6. The method of claim 1 wherein said LIFTRX transceiver has a synthesizer to generate a first carrier frequency for a transmitter unit and a second carrier frequency for a receiver, and said first carrier frequency is higher than said second carrier frequency.

7. The method of claim 1 wherein said LIFTRX transceiver provides an OQPSK modulated signal.

8. Apparatus for distance measurement using an average phase difference, comprising:
a first and a second LIFTRX transceiver, each comprising:
an antenna,
a switch for a transmitter unit and a receiver unit of said LIFTRX transceiver to mutual swapping,
a digital processor,
a crystal oscillator,
said receiver unit having a first band pass filter, a low noise amplifier a first mixer, two second filters, two ADCs in series connected to said digital processor,
said transmitter unit having a third band pass filter, a power amplifier, a second mixer, two fourth filters, two DACs, and
a frequency synthesizer for receiving a frequency from said crystal oscillator, receiving a first signal from said digital processor and outputting a first carrier frequency to said first mixer, outputting a second carrier frequency to said second mixer and outputting a second signal to said digital processor; and
said two TDCs of said first LIFTRX transceiver, each having a first input terminal connected to said frequency synthesizer and a second input terminal connected to one of said two second filters thereof; and
said two TDCs of said second LIFTRX transceiver, each having a first input terminal connected to said frequency synthesizer and a second input terminal connected to one of said of said second filters thereof.

9. The apparatus of claim 8 wherein said first carrier frequency is lower than said second carrier frequency.

10. The apparatus of claim 8 wherein said fourth filters are half sine shaping filters.

11. The apparatus of claim 8 wherein said first signal is amonotony-pulse signal.
